(19) United States
(12) Patent Application Publication
(10) Pub. No.: US 2024/0250625 A1
(43) Pub. Date: Jul. 25, 2024

(54) METHOD AND SAFETY SWITCH-OFF ARRANGEMENT FOR OPERATING A GENERATOR UNIT

(71) Applicant: SEG Automotive Germany GmbH, Stuttgart (DE)

(72) Inventors: Ralf HERBIG, Leonberg (DE); Patrick MAIER, Stuttgart (DE)

(21) Appl. No.: 18/565,669

(22) PCT Filed: May 31, 2022
(86) PCT No.: PCT/EP2022/064808

§ 371 Date: Nov. 30, 2023

(30) Foreign Application Priority Data
Jun. 1, 2021 (DE) 102021114189.3

(51) Int. Cl. H02P 9/00; H02P 101/45

(52) U.S. Cl. CPC H02P 9/006; H02P 2101/45

(57) ABSTRACT

A method for operating a generator unit which includes an electric machine which can be connected to an on-board power supply includes steps of, when an exciter voltage is applied to a rotor winding in order to generate an exciter current through the rotor winding and thus to provide an output voltage at a rectifier, a level of the output voltage is determined, wherein the rotor winding is de-excited via a first switch-off path when the output voltage reaches or exceeds a predetermined first safety threshold value for more than a predetermined first safety time, and wherein a controller output to which the rotor winding is connected is short-circuited via a second switch-off path when the output voltage reaches or exceeds a predetermined second safety threshold for more than a predetermined second safety time. The invention also relates to a corresponding safety switch-off arrangement.

The present invention relates to a method for operating a generator unit, a safety switch-off arrangement, a voltage regulator having such a safety switch-off arrangement, an arrangement having a generator unit and such a voltage regulator, and an on-board power supply, in particular an on-board power supply in a vehicle having such an arrangement.

### BACKGROUND OF THE INVENTION

Electric machines, in particular generators, can be used in motor vehicles to convert mechanical energy into electrical energy. Normally, claw pole generators, which are often equipped with electrical excitation capabilities, are used for this purpose. Since such generators usually produce a three-phase current, a rectification must take place for the direct current on-board power supply commonly found in vehicles. Rectifiers operating on the basis of semiconductor diodes or semiconductor switches can be used for this purpose.

To regulate the on-board power supply, an exciter current can in this case be controlled or regulated by the rotor winding of the generator. In other words, the controlled variable for the voltage regulation in vehicle generators is the exciter current, i.e., the current that flows through the rotor winding of the generator and generates the excitation field. This is usually realized by means of a switching unit of a voltage regulator (field controller), which can, e.g., comprise at least one switching transistor. The switching unit can switch the exciter current on and off. The exciter current or an exciter current-cycle ratio can in this case be modified such that the output voltage of the generator is set to the desired values.

In the event of a fault, e.g. if the voltage regulator is defective, the generator voltage and therefore the voltage of the on-board power supply can become too high, which can cause undesirable malfunctions of components and/or electrical devices in the on-board power supply. Some components in the on-board power supply can, e.g., limit their function or shut down completely to protect themselves. Even components and/or electrical devices in the on-board power supply may be damaged.

### DISCLOSURE OF THE INVENTION

The invention proposes a method for operating a generator unit, a safety switch-off arrangement, a voltage regulator having such a safety switch-off arrangement, an arrangement having a generator unit and such a voltage regulator and an onboard power supply, in particular an on-board power supply in a vehicle having such an arrangement and having the features of the independent claims. Advantageous embodiments are the subject matter of the dependent claims as well as the description hereinafter.

The invention relates to the prevention or reduction of overvoltage events in onboard power supplies and proposes for this purpose, on the one hand, to de-excite the rotor winding via a first switch-off path, in particular to quickly de-excite said winding, and, on the other hand, to short-circuit a controller output, to which the rotor winding is connected, via a second switch-off path and thereby also to short-circuit and switch off the current to the rotor winding. Two different, in particular redundant, switch-off paths or switch-off arrangements are provided thereby, which can also be realized in particular as independent safety switch-off devices and be used together as a safety switch-off arrangement, but which can, in principle, be realized independently as well in a voltage regulator or a generator unit. The use of a (conventional) voltage regulator, and therefore the application of exciter voltage to the rotor winding of the electric machine, is particularly suitable for the basic operation of the generator unit.

The use of a special safety switch-off device comes into consideration for both the de-excitation and the short-circuiting. This device can be integrated into the voltage regulator, but can, in particular, be connected as an add-on to a conventional voltage regulator or the actual control circuit device. This can, in particular, involve two separate safety switch-off devices, which can, however, be used together or combined in a common safety switch-off arrangement.

A de-excitation is in this case achieved in particular by guiding the current in the exciter winding through a diode, e.g. a Zener diode or one or more conventional diodes. The one or more diodes are also connected into the freewheeling path of the exciter winding to perform the de-excitation. For this purpose, the diode can be connected in parallel to a switch in the current path of the exciter winding, which switch is closed or conductively connected during normal operation. The diode is thus inoperative. If the output voltage is too high—which can, e.g., be determined using a voltage measuring device, this switch is then switched to be non-conductively connected or opened. The current then flows via the diode, where it is dissipated more quickly (or converted into heat).

The phrase “short-circuiting the exciter terminal” means in particular that the voltage applied to this terminal (e.g., the on-board power supply or the battery voltage) is removed from the exciter winding. For this purpose, as mentioned, the exciter output of the voltage regulator, via which the exciter voltage is normally applied to the exciter winding, is grounded or short-circuited. If the output voltage is too high—which can, e.g., be determined using a voltage measuring device—then a switch connected in parallel to the rotor winding can, e.g., be switched to be conductively connected or closed. Depending on the configuration, this will also mean short-circuiting the exciter winding. This short-circuiting usually causes irreversible damage to the voltage regulator, because the voltage regulator is not designed for such a high current. It is basically sacrificed. Preferably, however, an additional fuse element, such as a fuse, which is arranged in the current path of the voltage regulator, is destroyed instead of the voltage regulator. In any case, however, the short-circuiting is ultimately intended to result in the current to the exciter winding being switched off.

In this context, both the de-excitation and the short-circuiting then take place when the output voltage reaches or exceeds a predetermined safety threshold for longer than a predetermined safety time. A first safety threshold and a first safety time can be used for the de-excitation, while a second safety threshold and a second safety time can be used to switch off the current. These two safety times can in the present case be the same or different. This also applies to the safety thresholds.

The two switch-off paths are in this case preferably activated one after the other, i.e., a cascaded switch-off is provided. For this purpose, the second safety time can be selected to be longer than the first safety time. Alternatively, or additionally, it is preferable if the second safety threshold is higher than the first safety threshold.

In particular, the first safety time can also be zero, i.e., the de-excitation process is triggered immediately in the event of an overvoltage, but it can, e.g., also be up to 100 ms. The second safety time is preferably shorter than 1 second, e.g., between 100 ms and 500 ms. The safety times can be specified in particular on the basis of the dielectric strength of on-board power consumers, i.e., how long they can withstand which overvoltage levels. The first safety threshold is preferably specified on the basis of a nominal on-board power supply voltage and can, for example, range from approximately 110% to approximately 150% of the nominal on-board power supply voltage. At a nominal voltage of 12 V, the first safety threshold can, e.g., be between 15.0 V and 16.7 V. The second safety threshold is then, e.g., from 0.3 V to 1.0 V higher than the first safety threshold. Both can be specified in particular on the basis of the dielectric strength of on-board power consumers, i.e., how long they can withstand which overvoltage levels.

One particular advantage of this cascaded triggering is that the de-excitation process, which is performed first, can be reversed. Only the current removal process cannot be reversed due to the damage it causes to the voltage regulator or a fuse. As a result, a high level of safety integrity can be achieved for multiple faults, e.g. ASIL C or ASIL D. The cascading can also be increased by means of additional switches and additional redundancies.

Preferably, different technologies and/or component manufacturers are used for the two switches or circuit breakers for the de-excitation or the removal of current, in particular also for the control or control circuits necessary thereby due to possible “common cause” errors. Although a (common) voltage measuring device can generally be considered for both switches and switch-off paths, it is particularly preferable to use two different devices in order to increase redundancy.

The controls of the two switches are advantageously designed such that they have a very low quiescent current when the generator is switched off (generator not rotating). For this purpose, the control for the current removal switch is designed as ‘high active’, and the de-excitation switch is designed as ‘low active.’ In order to also protect the independently redundant circuit parts against polarity reversal for a higher safety integrity, a polarity reversal element such as a diode can be used, which is connected between the positive input terminal and the at least one voltage measuring device.

In summary, the on-board power supply or, the consumers thereof, are thereby protected in a special manner against an overvoltage caused by a generator malfunction. The generator can be transitioned to a defined state in which overvoltage is no longer possible. This enables the generator to be used in safety-relevant on-board power supplies and for high safety integrity requirements to be met due to the multi-redundant cascading. A variation of the number results in a modular system for different safety integrity requirements. In addition, a reduction in the quiescent current and the fulfillment of the generator function are also achieved in the event of an external start with more than 20 V.

A short-circuit protection of the internal control circuit and the independently redundant circuit parts can be achieved by using the additional fuse element such as a fuse, which was already mentioned. A reverse polarity protection of the independently redundant circuit parts, which further increases the safety integrity, can be achieved by means of a diode. The invention thereby offers the further advantage that a safety switch-off functionality, in particular in the form of safety switch-off devices, can be retrofitted. Any traditional control circuit device, e.g., in the form of ICs or ASICs, would not have to be modified. This facilitates the realization of a modular safety system in which suitable products can be combined depending on the safety requirements. In other words, the invention offers the advantage that a safety switch-off can be provided individually in or for voltage regulators, as needed.

Furthermore, the invention offers the advantage that, e.g., a mass production of standardized safety switch-off devices can be performed, which can then be added to voltage regulators as desired.

Preferably, an on-board power supply or an output voltage provided by the rectifier is applied to the rotor winding as the exciter voltage. The on-board power supply voltage can then be monitored at the same time by monitoring the level of the exciter voltage. This embodiment is very easy to implement, because the exciter voltage conventionally corresponds to the on-board power supply voltage.

Preferably, the exciter or output voltage is also used to supply power to the safety switch-off arrangement or the safety switch-off devices. No separate supply is required thereby, which improves in particular the robustness against faults in the on-board power supply and reduces the risk of a short circuit between the supply potential (B+) and the ground.

Further advantages and embodiments of the invention can be gathered from the description and the accompanying drawing.

The invention is illustrated schematically by means of embodiments in the drawings and described hereinafter with reference to the drawings.

### BRIEF DESCRIPTION OF THE DRAWINGS

FIG. 1 shows a circuit diagram of an electrical system with a safety switch-off arrangement with two safety switch-off devices.

### EMBODIMENT OF THE INVENTION

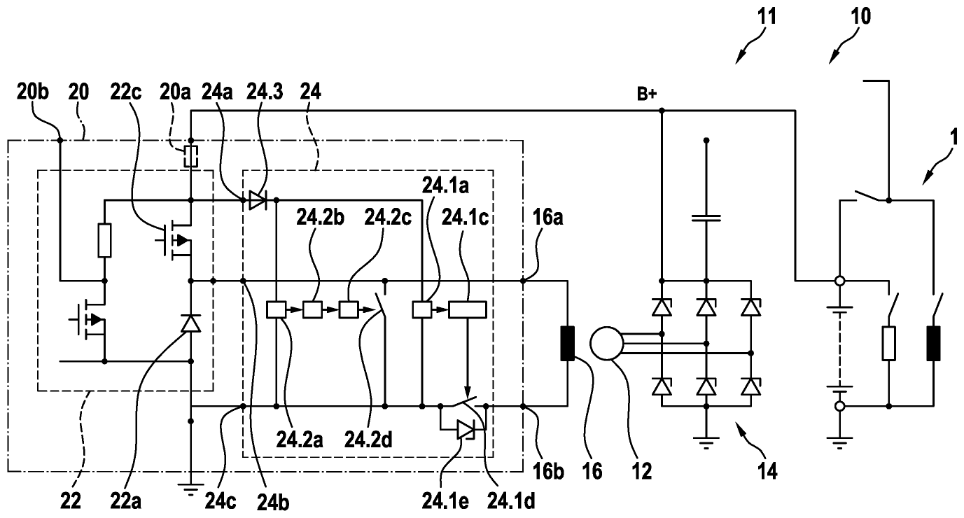

FIG. 1 shows a circuit diagram of an on-board power supply 10, in particular of a (motor) vehicle, having a voltage source 11 and consumers or a battery 1.

The voltage source 11 comprises an electric machine or a generator having a stator 12, a rectifier 14 located downstream from the stator, a rotor with a rotor winding 16, which can be driven in particular by a vehicle engine, and a preferred embodiment of a voltage regulator 20 according to the invention (also referred to as a field controller) for specifying an exciter current through the rotor winding 16 or for regulating a generator voltage. The purpose of the voltage regulator 20 is to regulate the generator voltage between the terminals B+ and the ground to a desired value, e.g., approximately 14-15 V for what is referred to as 12 V onboard power supply with 12 V nominal voltage. The generator voltage is therefore the rectified output voltage of the generator or the on-board power supply voltage.

The voltage regulator 20 comprises the actual control circuit device 22, which can, e.g., be designed as an application-specific integrated circuit (ASIC), and a preferred embodiment of a safety switch-off arrangement 24 according to the invention, which comprises two safety switch-off devices 24.1 and 24.2 for two switch-off paths. The voltage regulator 20, the control circuit device 22 and the safety switch-off device 24 are each identified by the surrounding dashed lines. The two safety switch-off devices are preferably separated in terms of their circuitry and components, but can, e.g., also be arranged on a common circuit carrier.

The control circuit device 22 comprises a switch 22c, for example a semiconductor switch such as a MOSFET, IGBT or Thyristor, by means of which the current flowing through the rotor winding 16 can be switched, as well as a diode 22a for the freewheeling of the exciter current. The diode 22a can also be designed as a semiconductor switch. Furthermore, a communication terminal 20b is provided in order to, e.g., be able to specify a desired voltage.

The voltage regulator 20 is connected to the rotor winding 16 via a first terminal 16a and a second terminal 16b. These terminals also represent output terminals of the safety switch-off arrangement 24. It should be emphasized that the rotor winding is arranged on the rotor of the electric machine and not inside the voltage regulator 20.

The safety switch-off arrangement 24 comprises a positive potential terminal 24a, an exciter terminal 24b, and a negative potential terminal 24c, which are connected to corresponding terminals of the control circuit device 22 (or will be connected during a retrofit). The positive potential terminal 24a is used to connect to B+, the negative potential terminal 24c to connect to the ground and the exciter terminal to connect to the exciter output (referred to as DF) of the control circuit device in order to be able to apply the voltage to the exciter winding. These terminals are supplied to both safety switch-off devices 24.1 and 24.2 independently of each other.

When the voltage regulator is operating normally, the switch 24.1d is closed. The first voltage measuring device 24.1a monitors or determines the output voltage at B+. If it increases, for example due to a load dump or a fault in the regulator, and the first safety threshold is exceeded, a first trigger circuit 24.1c switches the switch 24.1d to be non-conductive or off. Normally, the switch 22c of the control circuit device 22 is opened due to the overvoltage as well. The current continues to flow through the Zener diode 24.1e and the freewheeling diode 22a due to the inductance. Due to the Zener effect, the energy in the exciter circuit or the exciter winding 16 dissipates faster. The rapid dissipation of the exciter current means that the overvoltage time can be reduced in the event of a load dump. After the voltage has subsided, the switch 24.1d is closed again, and the safe state can be reversibly activated and deactivated. The diode 24.1e could also optionally be designed not as a Zener diode, but one having one or more diodes in order to reduce the error rate of the individual components.

In addition, an independent, second voltage measuring device 24.2a is provided, which is able to determine the output voltage as well. If the associated second safety threshold is exceeded (e.g., if the voltage regulator is defective and the switch 22c does not open), a second control circuit 24.2c, via which the second switch 24.2d can be closed or switched to a conductive mode, is activated via a time delay element 24.2b, which means that it possible to wait for a second safety time. When the switch 24.2d is activated, the exciter input terminal 24b is conductively connected to the ground. As a result, a high current flows through the control circuit device 22, which will generally cause it to be damaged or destroyed. Alternatively, this can cause a fuse element 20a to be triggered. In any event, this results in the exciter winding 16 being de-excited and thus in a safe state (voltage at B+ below the second safety threshold). At the same time, the exciter winding is short-circuited. The current can then be dissipated via the diode 24.1 e, which is still present in the freewheeling path; or, if the circuit or the switch-off path 24.1. had not worked, via a normal short circuit.

As mentioned, it is possible to insert the fuse element 20a, such as a fuse, into the supply of B+, which is triggered in the event of a short circuit. This fuse element has the advantage that in the event of an internal short circuit in the controller IC or in the independently redundant circuit parts, a possible overvoltage and also the destruction of circuits can be prevented.

The first and second safety thresholds in this case are in particular set such that the first safety threshold is lower than the second safety threshold by a difference of, e.g., from 0.3 V to 1.0 V. The first safety threshold can be within an absolute range from 15.0 V to 16.7 V. This has the advantage that a reversible state is assumed if and only if the first redundancy fails or is ineffective (e.g., switch 24.1d due to a short circuit, hence if, e.g., the first switch-off path 24.1 does not function and/or, e.g., switch 22c is defective), the system switched to an irreversible state. A high level of safety integrity for multiple faults is ensured as a result. The cascading can also be increased by means of additional switches and additional redundancies.

The two switches—which in this case can in particular be power switches such as MOSFETs or IGBTs—and the controls of the two switches preferably use different technologies or component manufacturers due to possible “common cause” faults. The controls of the two switches are, e.g., designed such that they have a very low quiescent current when the generator is switched off (generator not rotating). For this purpose, the control for switch 24.2d is designed to be ‘high active’, and the control for switch 24.1d is designed to be ‘low active’.

In order to protect the independently redundant circuit parts against a polarity reversal and thus to achieve a higher safety integrity, a polarity element with the diode 24.3 can be installed as well.

1. A method for operating a generator unit which comprises an electric machine with a rotor winding (16) and a stator winding (12), and a rectifier (14) which is connected thereto and via which the electric machine can be connected to an onboard power supply (10),
wherein, when an exciter voltage is applied to the rotor winding (16) in order to generate an exciter current through the rotor winding (16) and thus to provide an output voltage at the rectifier (14), a level of the output voltage is determined,
wherein the rotor winding (16) is de-excited via a first switch-off path when the output voltage reaches or exceeds a predetermined first safety threshold for more than a predetermined first safety time, and
wherein a controller output, to which the rotor winding (16) is connected, is short-circuited via a second switch-off path when the output voltage reaches or exceeds a predetermined second safety threshold for more than a predetermined second safety time.

2. The method according to claim 1, wherein the second safety time is longer than the first safety time.

3. The method according to claim 1, wherein the second safety threshold is higher than the first safety threshold.

4. The method according to claim 1, wherein the rotor winding (16) is de-excited, in particular rapidly de-excited, by a switch (24.1c) being connected in a non-conductive manner, which switch is connected in a freewheeling path of the rotor winding (16), in particular between the rotor winding (16) and ground, or between the rotor winding and an exciter terminal, and to which a diode (24.1d) is connected in parallel.

5. The method according to claim 1, wherein an exciter terminal is short-circuited by a switch (24.1d) between the exciter terminal and the ground being connected in a conductive manner so that the rotor winding (16) is short-circuited.

6. The method according to claim 1, wherein the level of the output voltage for the de-excitation is determined by means of a first voltage measuring device (24.1a), and wherein the level of the output voltage for the short-circuiting is determined by means of a second voltage measuring device (24.2a) which is different from the first voltage measuring device (24.1a).

7. The method according to claim 1, wherein output voltage is applied to the rotor winding (110) as the exciter voltage.

8. A safety switch-off arrangement (24) for use in a voltage regulator (20), which is configured for operating a generator unit, which comprises an electric machine with a rotor winding (16) and a stator winding (12) and a rectifier (14) which is connected thereto and via which the electric machine can be connected to an on-board power supply (10),
wherein the safety switch-off arrangement (24) comprises two output terminals (16a, 16b), between which terminals the rotor winding (16) is to be connected, said arrangement also comprising a positive input terminal (24a), a negative input terminal (24c), and an exciter input terminal (24b),
wherein the safety switch-off arrangement (24) comprises a first safety switch-off device for a first switch-off path, which device is configured to de-excite the rotor winding,
wherein the safety switch-off arrangement (24) comprises a second safety switch-off device for a second switch-off path, which device is configured to short-circuit the rotor winding,
wherein the safety switch-off arrangement (24) is configured to determine a voltage between a positive input terminal (24a) and a negative input terminal (24c), to perform the de-excitation via the first switch-off path when the output voltage reaches or exceeds a predetermined first safety threshold for more than a predetermined first safety time, and to perform the short-circuiting via the second switch-off path when the output voltage reaches or exceeds a predetermined second safety threshold for more than a predetermined second safety time.

9. The safety switch-off arrangement (24) according to claim 8, comprising at least one voltage measuring device (24.1a, 24.2a) for determining the voltage between the positive input terminal (24a) and the negative input terminal (24c), and/or comprising a diode (24.3) between the positive input terminal (24a) and the at least one voltage measuring device (24.1a, 24.2a).

10. A voltage regulator (20) for operating a generator unit, which comprises an electric machine with a rotor winding (16) and a stator winding (12) and a rectifier (14) which is connected thereto and via which the electric machine can be connected to an on-board power supply (10),
and comprises a safety switch-off arrangement according to claim 8.

11. The voltage regulator (20) according to claim 10, comprising a fuse device (20a) at a positive potential terminal.

12. An arrangement having a generator unit which comprises an electric machine with a rotor winding (16) and a stator winding (12) and a rectifier (14) which is connected thereto and via which the electric machine can be connected to an on-board power supply (10), and comprising
a voltage regulator (20) including a safety switch-off arrangement according to claim 8.
An on-board power supply (10) having a voltage source (11) and at least one consumer (1), wherein the voltage source (11) comprises an arrangement having a generator unit which comprises an electric machine with a rotor winding (16) and a stator winding (12) and a rectifier (14) which is connected thereto and via which the electric machine can be connected to an on-board power supply (10), and comprising a voltage regulator (20), including a safety switch-off arrangement according to claim 8.
